(19) United States
(12) Patent Application Publication
(10) Pub. No.: US 2025/0204509 A1
(43) Pub. Date: Jun. 26, 2025

(54) EQUINE SHOE WITH INTERCHANGEABLE TRACTION SYSTEM

(71) Applicant: EasyCare, Inc., Durango, CO (US)

(72) Inventors: Garrett Ford, Durango, CO (US); Aksel Vibe, Favang (NO); Peder Fredrickson, Vitaby (SE)

(73) Assignee: EasyCare, Inc., Durango, CO (US)

(21) Appl. No.: 18/999,470

(22) Filed: Dec. 23, 2024

Related U.S. Application Data
(60) Provisional application No. 63/614,280, filed on Dec. 22, 2023.
(60) Provisional application No. 63/620,398, filed on Jan. 12, 2024.

(51) Int. Cl. A01L 1/04

(52) U.S. Cl. CPC A01L 1/04

(57) ABSTRACT

An equine shoe having interchangeable and removable cleats and traction spikes.

### CROSS-REFERENCE TO RELATED APPLICATIONS

This application claims the priority benefit of U.S. Provisional Application No. 63/614,280, filed Dec. 22, 2023, and U.S. Provisional Application No. 63/620,398, filed Jan. 12, 2024, each of which is incorporated in its entirety by reference herein.

### FIELD OF THE INVENTION

This patent application relates to equine shoes with improved traction.

### BACKGROUND

Modern equine shoes are used to protect the hooves of horses and are often used in lieu of traditional steel or aluminum shoes. Such modern shoes typically includes a sole with a flat top surface that meets the underside of the hoof and an upper that projects upward from the sole and forms a peripheral enclosure for at least part of the hoof of the horse. A subset of modern shoes includes one or more traction spikes to improve traction in difficult conditions.

Shoes that implement traction spikes, unfortunately, have significant shortcomings in connection with durability and traction. That is, the traction spikes, and in turn, their securing mechanisms, are subjected to significant loads and high impacts during use. Over time, repeated high impacts can damage the spikes and/or their securing mechanisms. Eventually, the damage reaches a point where the spikes and/or their securing mechanisms fail and can be dislodged. Depending on the circumstances and terrain, upon failure or dislodging of a traction spike and/or the securing mechanism, the horse may lose traction. In any event, upon failure of these components, the shoe must be replaced. Moreover, while traction spikes often improve traction compared to conventional shoes, there are a number of circumstances wherein traction spikes provide insufficient traction.

What is needed, therefore, is an equine shoe that improves upon or resolves one or more of these drawbacks.

### SUMMARY

This application discloses a urethane horse shoe with embedded bridges, tee nuts connected to such bridges, and interchangeable cleats and traction spikes.

### BRIEF DESCRIPTION OF DRAWINGS

Embodiments of the application will be described in detail in conjunction with FIGS. 1-26.

FIG. 1 is a perspective bottom view of an equine shoe according to the disclosure.

FIG. 2 is a perspective bottom view of an equine shoe according to the disclosure.

FIG. 3 is a perspective bottom view of an equine shoe according to the disclosure.

FIG. 4 is a perspective bottom view of an equine shoe sole according to the disclosure.

FIG. 5 is a bottom view of an equine shoe according to the disclosure.

FIG. 6 is a bottom view of an equine shoe according to the disclosure.

FIG. 7 is a perspective bottom view of an equine shoe according to the disclosure.

FIG. 8 is a partially transparent, perspective bottom view of an equine shoe according to the disclosure.

FIG. 9 a perspective bottom view of an equine shoe according to the disclosure.

FIG. 10 is a bottom view of an equine shoe according to the disclosure.

FIG. 11 is a perspective bottom view of an equine shoe according to the disclosure.

FIG. 12 is a bottom view of an equine shoe according to the disclosure.

FIG. 13 is a perspective bottom view of an equine shoe according to the disclosure.

FIG. 14 is a perspective bottom view of an equine shoe according to the disclosure.

FIG. 15 is a perspective bottom view of an equine shoe according to the disclosure.

FIG. 16 is a perspective bottom view of an equine shoe according to the disclosure.

FIG. 17 is a partial perspective bottom view of an equine shoe according to the disclosure.

FIG. 18 is a partial perspective bottom view of an equine shoe according to the disclosure.

FIG. 19 is a partial perspective bottom view of an equine shoe according to the disclosure.

FIG. 20 is a partial perspective bottom view of an equine shoe according to the disclosure.

FIG. 21 is a perspective side view of cleats according to the disclosure.

FIG. 22 is a perspective side view of cleats according to the disclosure.

FIG. 23 is a perspective side view of cleats according to the disclosure.

FIG. 24 is a perspective side view of cleats according to the disclosure.

FIG. 25 is a top view of an equine shoe according to the disclosure.

FIG. 26 is a perspective side view of the top of an equine shoe according to the disclosure.

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

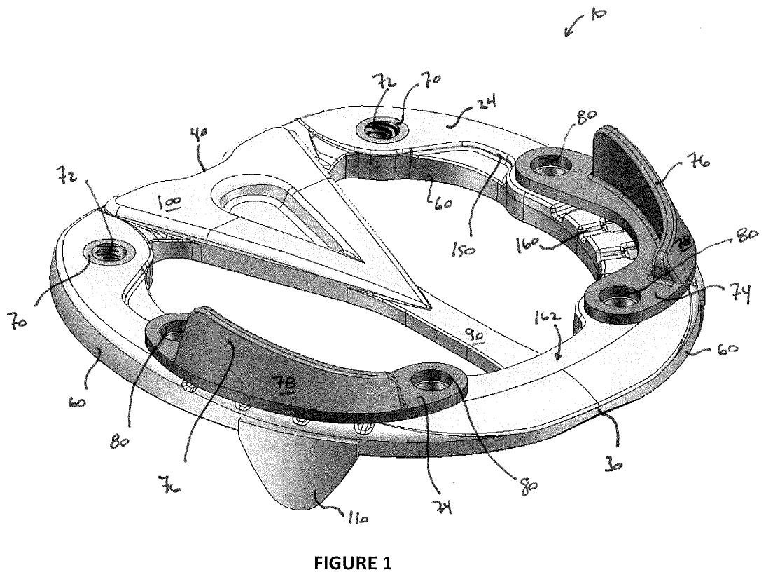

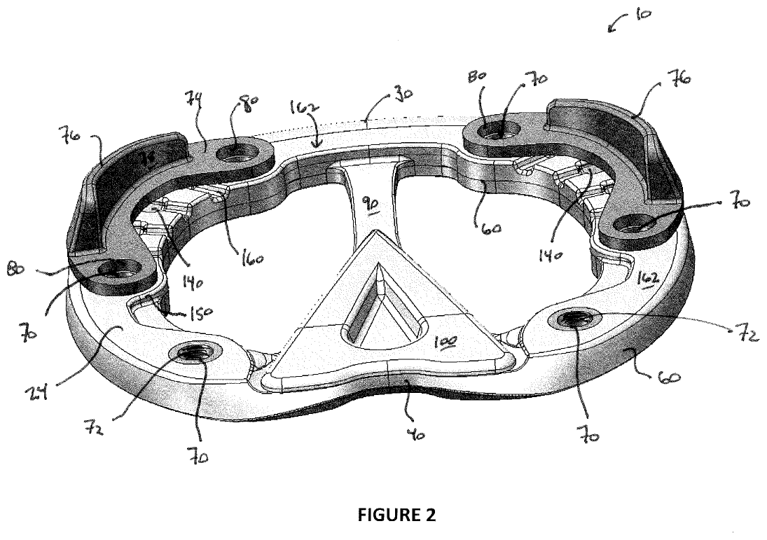

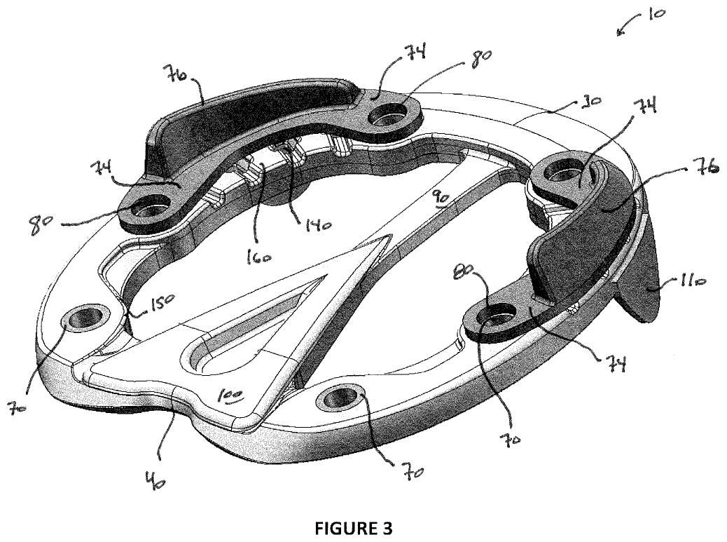

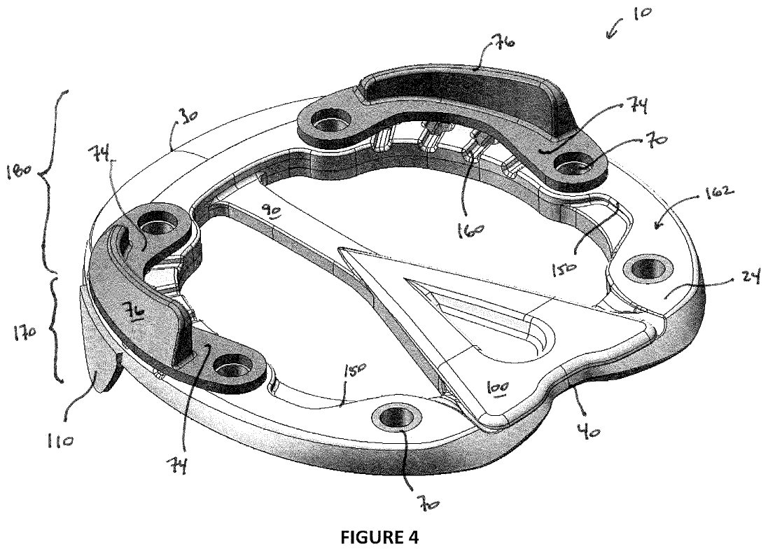

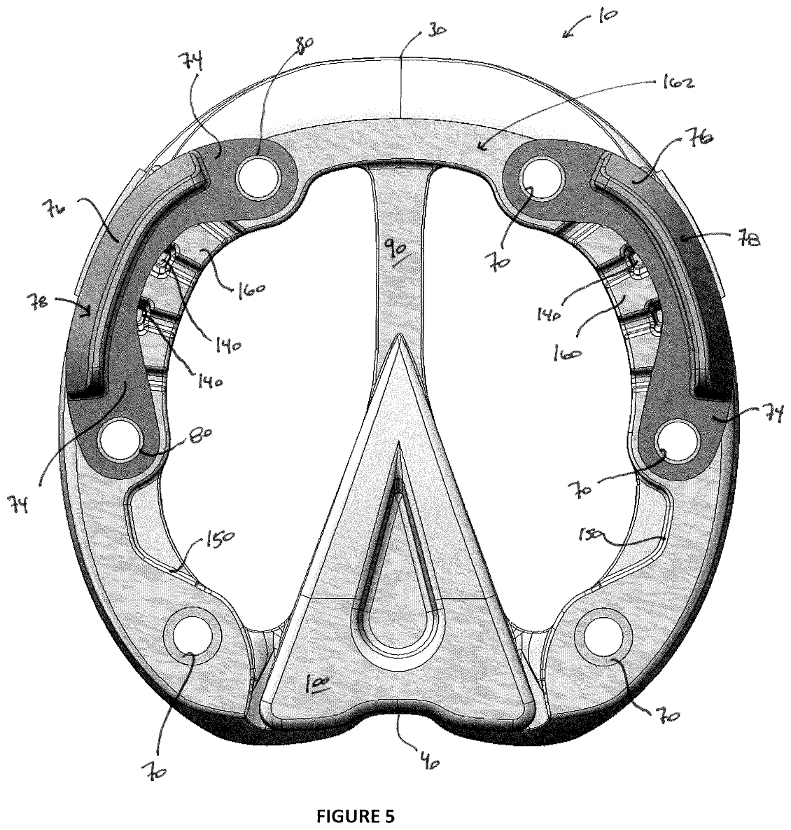

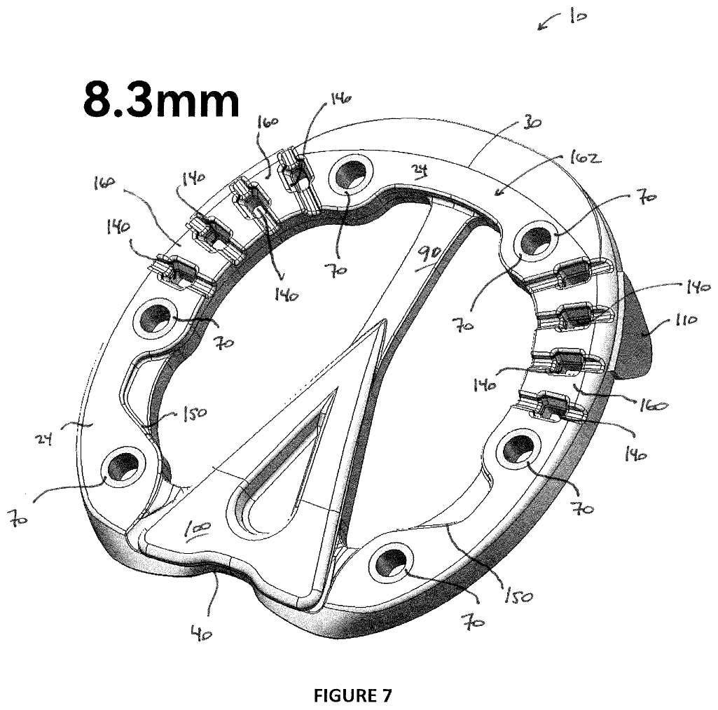

Embodiments of the present disclosure are best understood by referring to FIGS. 1-9 of the drawings, like numerals being used for like and corresponding parts of the various drawings.

### LIST OF REFERENCES

10 Shoe
20 Platform
24 Sole
28 Sole Superior Surface
30 Distal End
40 Proximal End
60 Lateral Wall
64 Threaded Fastener
70 Tee Nut
72 Thread
74 Bracket
76 Cleat
78 Curved Wall
79 Frustoconical Cleat
80 Bracket Hole
84 Traction Spike
90 Longitudinal Support
100 Frog Support
110 Distal Tab
120 Support Bridge
126 Hole
140 Fenestration
142 Passageway
150 Ridge
160 Tread
162 Bottom
170 Superior end
180 Inferior end

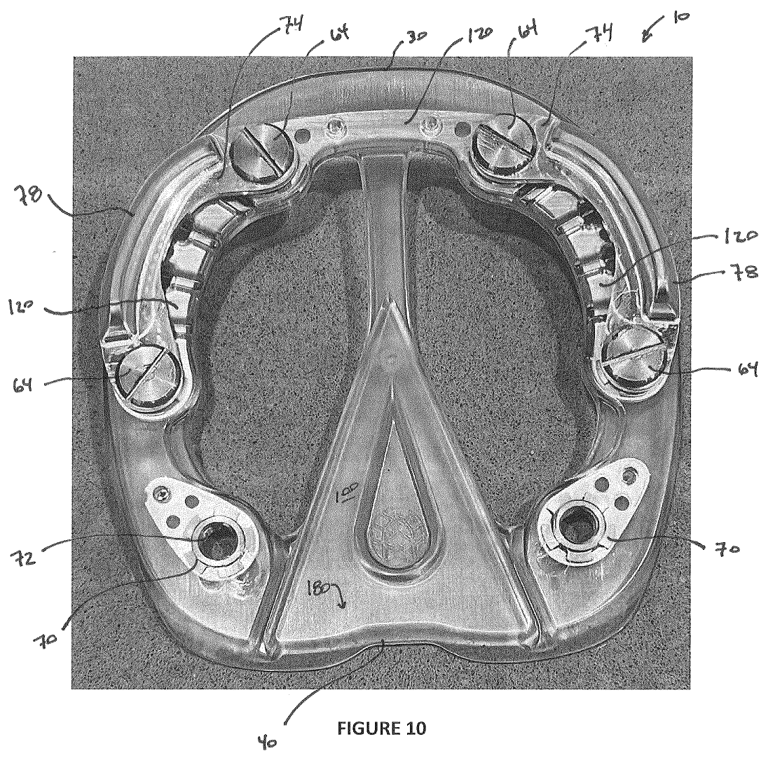

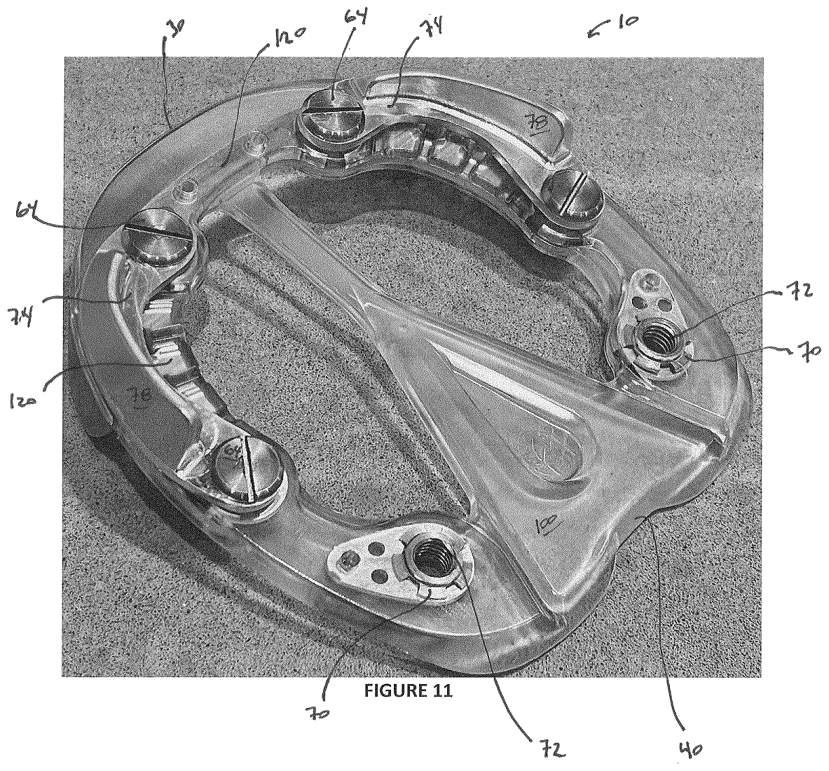

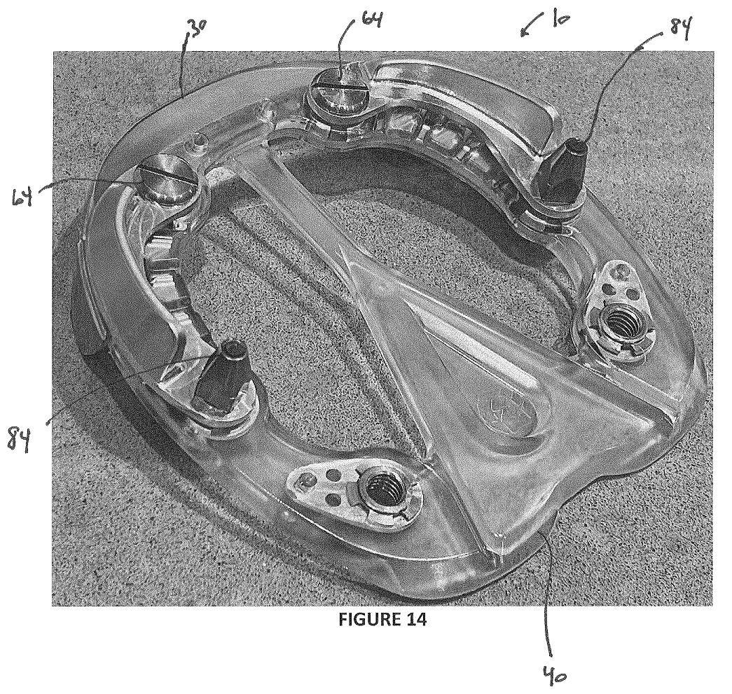

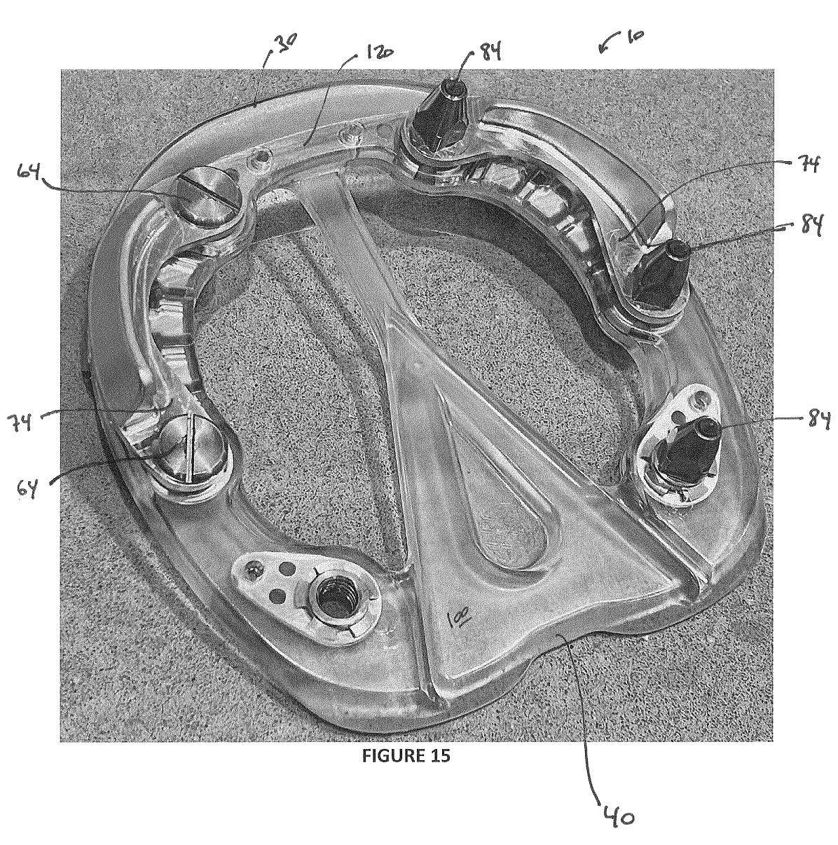

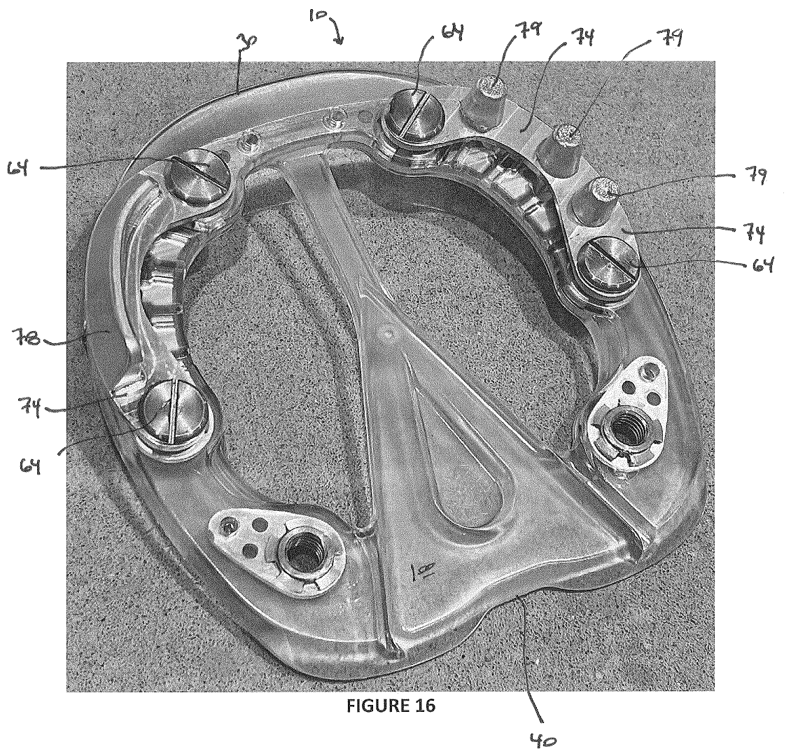

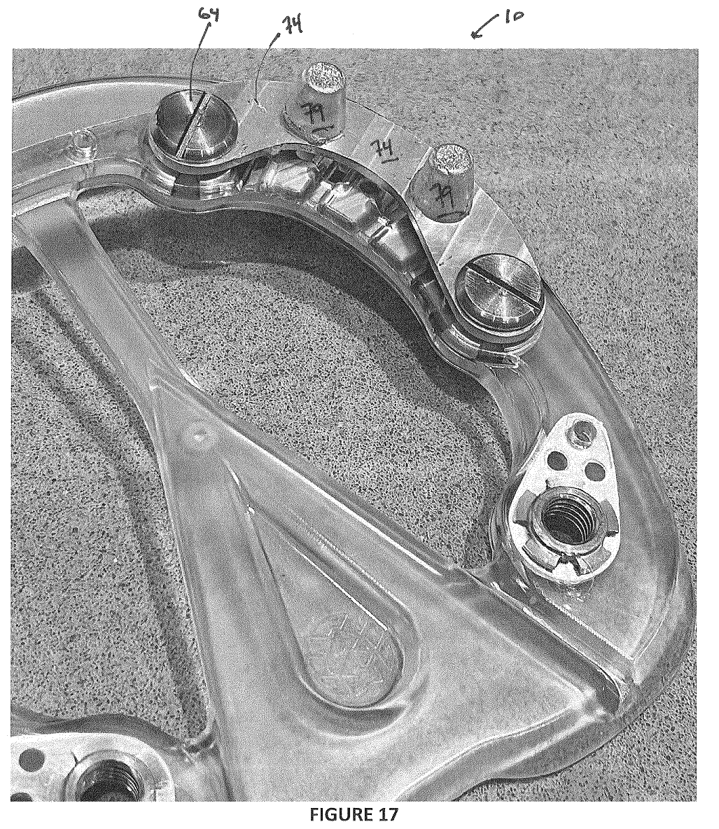

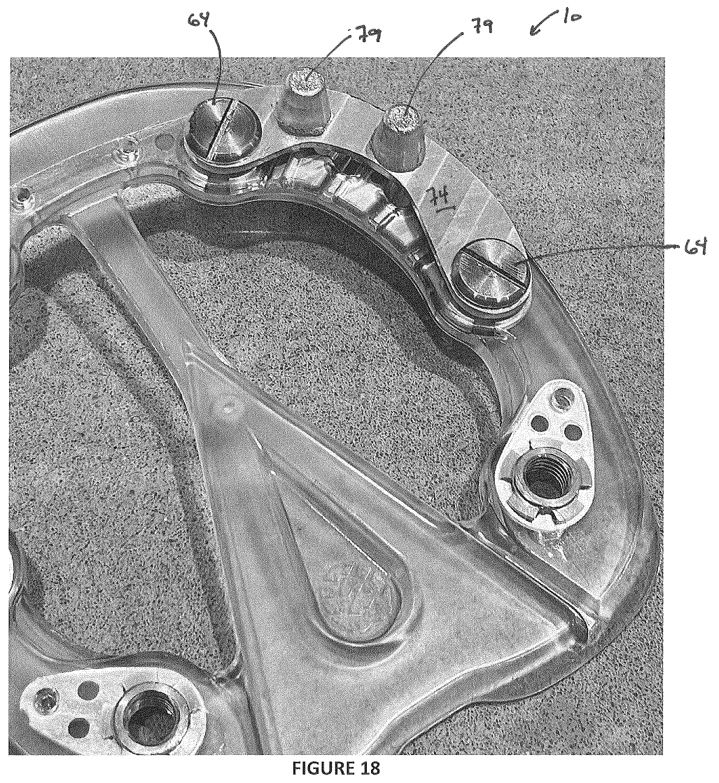

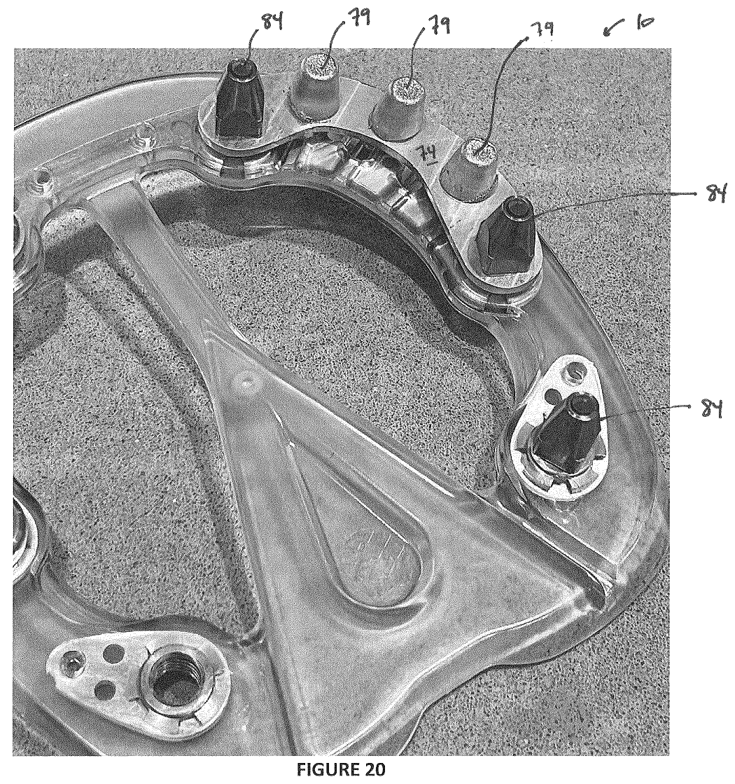

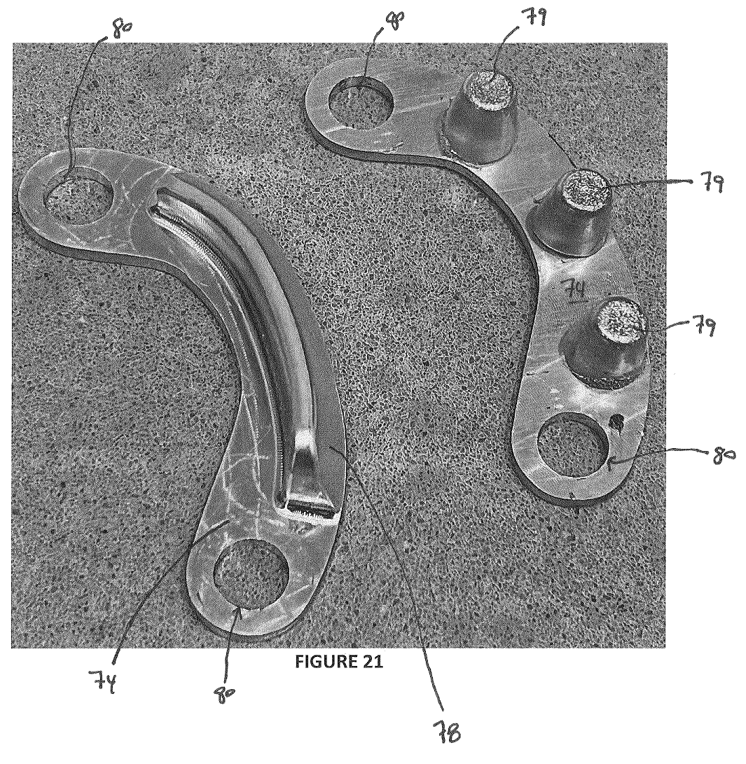

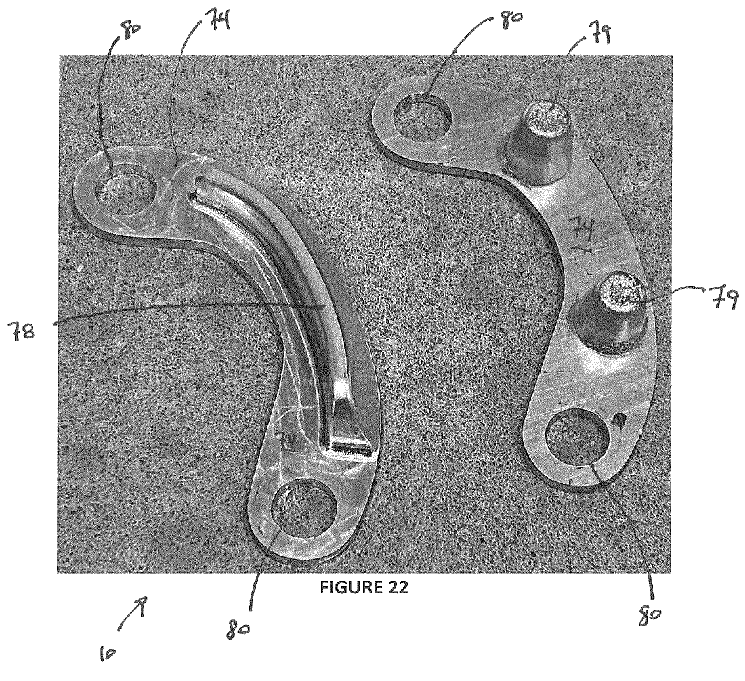

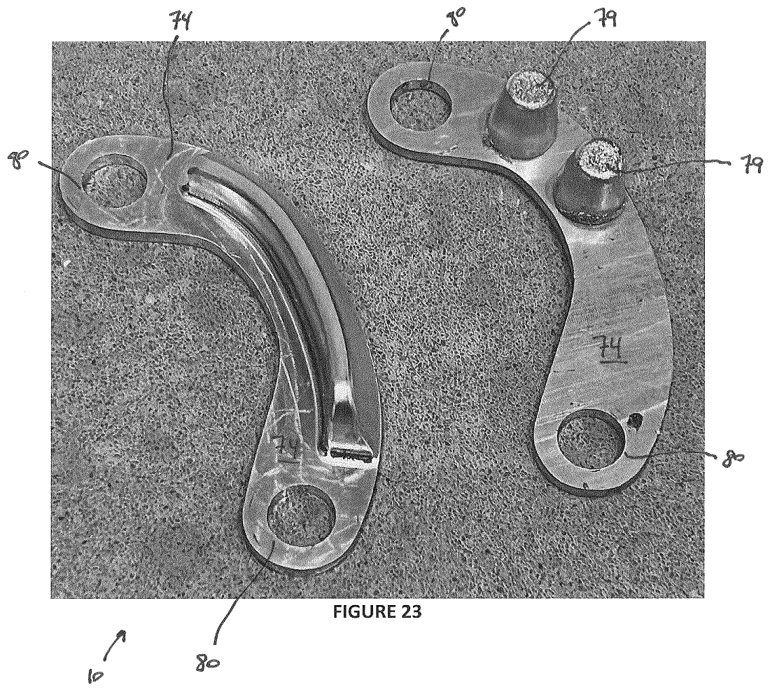

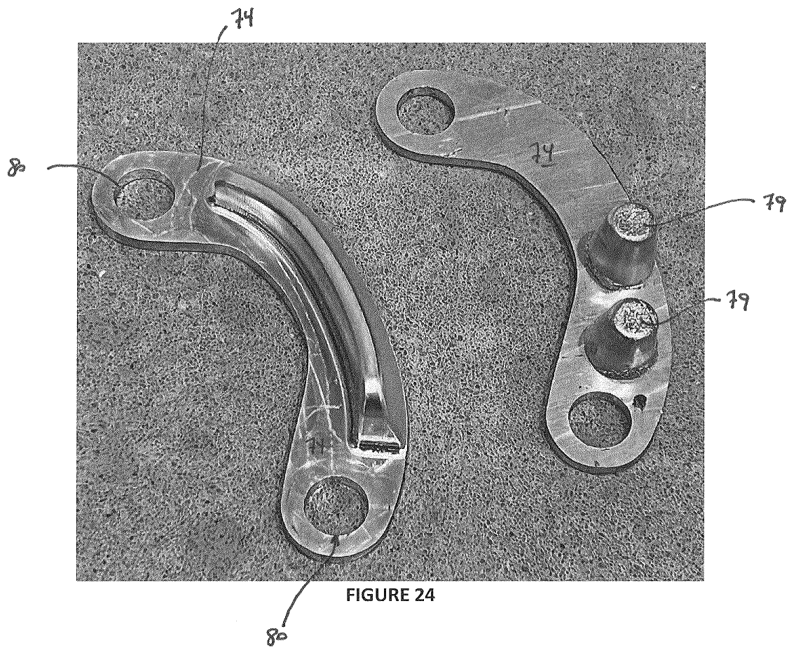

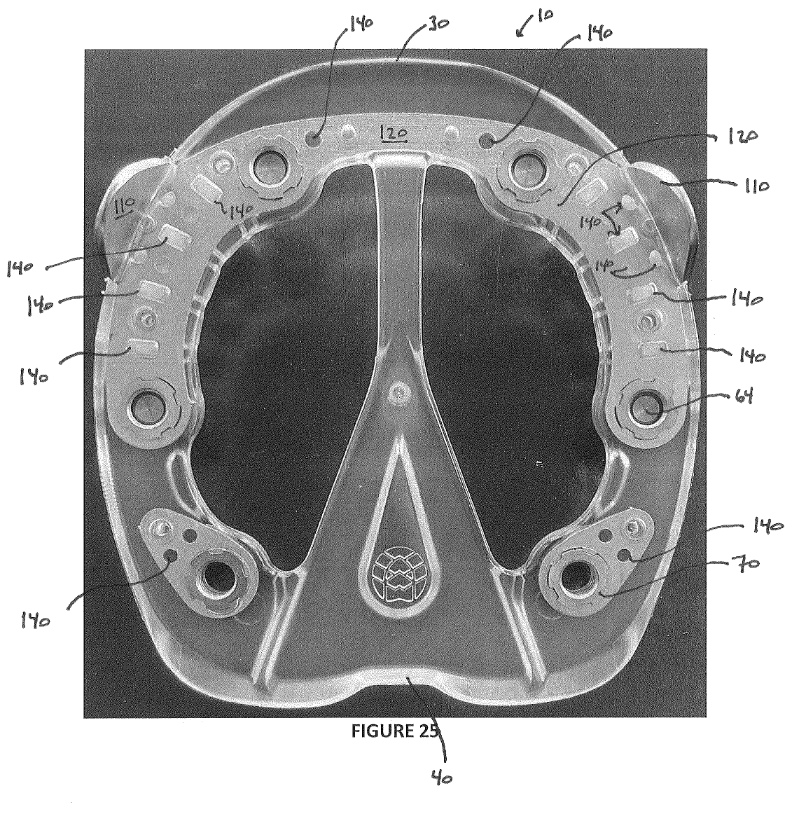

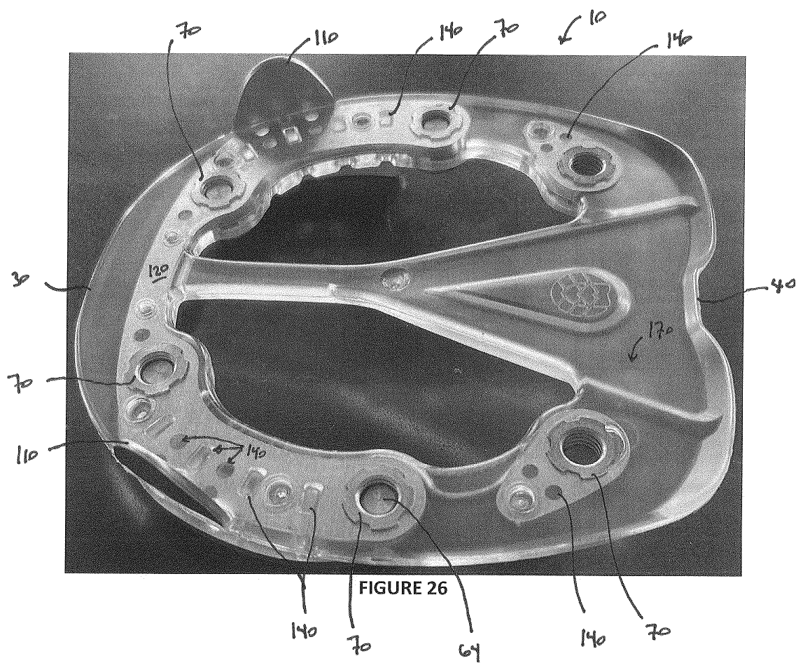

In general, referring to FIGS. 1-26, shoe 10 has a proximal end 40, a distal end 30, a superior end 170 and an inferior end 180, a bottom 162, lateral walls 60 and sole 24. Shoe 10 further includes a longitudinal support 90 that connects frog support 100 to the distal end 30 of the shoe. A bridge 120 is fully or partially embedded in sole 24. As shown in FIGS. 25-26, support bridge 120 can be provided with a distal tab 110 that extends in a superior direction from sole 24. Bridge 120 is provided with holes for receiving and securing threaded tee nuts 70 having threads 72. Additionally, bridge 120 is provided with a number of fenestrations 140, as shown in FIGS. 25-26. The tee nuts are configured to interchangeably receive and rigidly secure a cleat 76 or a traction spikes 84. Cleats 76 have an integrated bracket 74 with holes that allow the cleats to be fastened to the tee nuts in the sole by fasteners 64. In addition, shoe 10 is provided with treads 160, such that shoe 10 can be utilized when cleats or traction spikes are not needed.

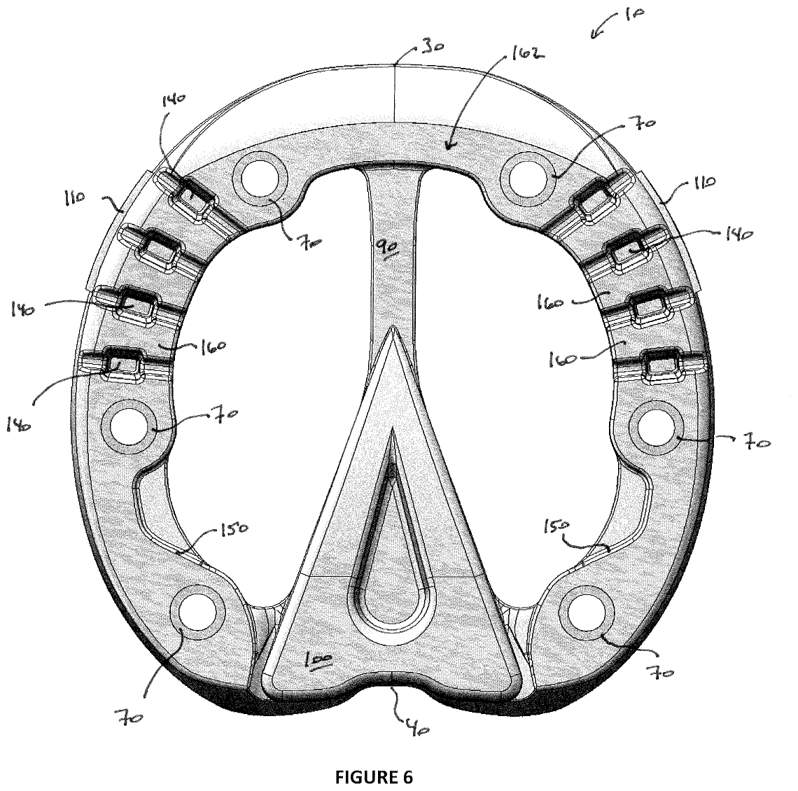

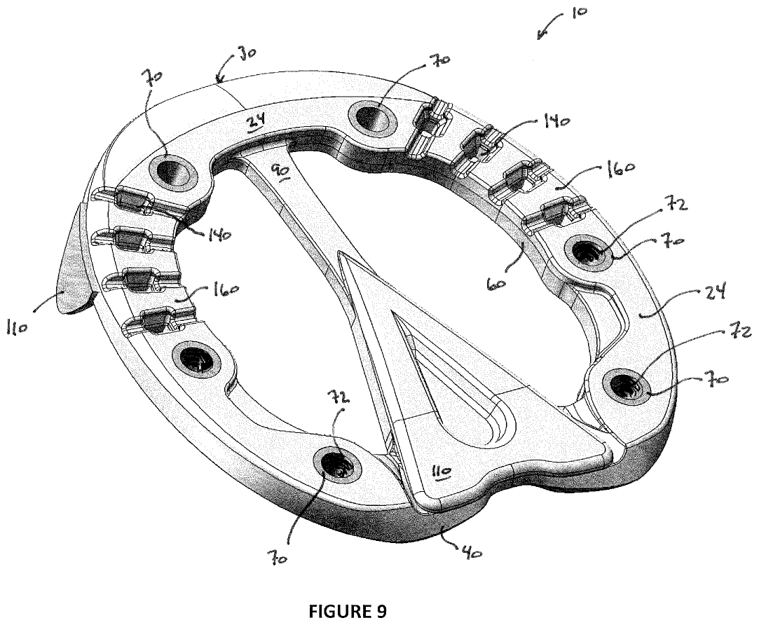

As best illustrated in FIGS. 6-9 and 25-26, shoe 10 includes a sole 24, which is formed from a polymer material. Sole 24 provides a bottom surface 162 configured to protect a horse foot. Sole 24 is designed to cover and correspond with and naturally accommodate the weight bearing structures of a horse foot, i.e., the wall, sole and frog. In one embodiment provided with treads 160, shown in FIG. 9, shoe 10 is provided with a central opening that generally corresponds with the sole of the horse foot. The central opening is bisected by longitudinal support 90 and frog support 100. Optionally, treads 160 and ridge 150 can be integrated into sole 24 so as to provide sufficient traction for use in conditions where cleats or traction spikes are unneeded. For example, such treads add necessary traction when the horse is pastured, stalled or in transit.

In one embodiment shoe 10 is molded of a material that can be shaved, such as urethane. This permits a user to precisely shave the proximal and/or the distal ends to conform to the size and shape of the horse toe and/or heel. The more precise proximal fit reduces the likelihood of the shoes interfering with a horse's gallop or other movement.

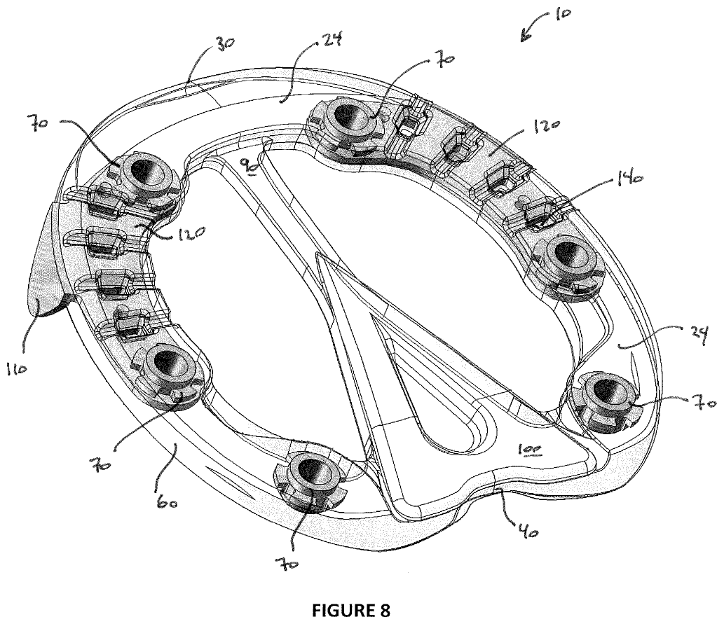

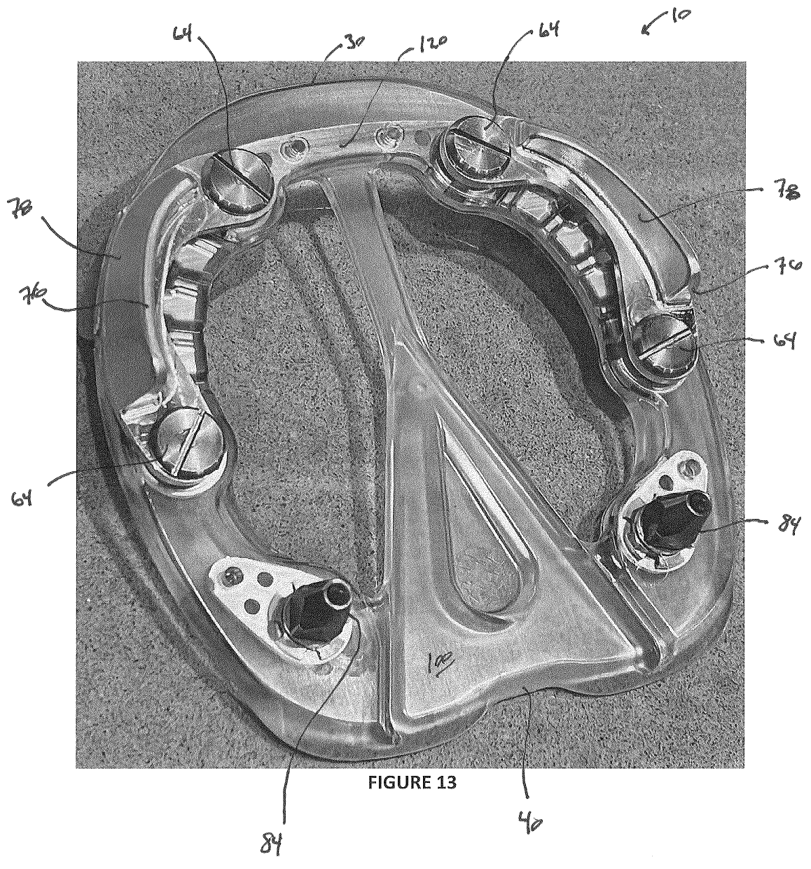

Referring to FIGS. 8, 10-13, and 25-26, in one embodiment, shoe 10 includes support bridges 120. Bridge 120 is made of a structurally rigid material such as a metal, metal alloy or highly rigid polymer. Bridge 120 is provided with holes 126 for receiving and securing threaded tee nuts 70 having threads 72. This permits a user to secure cleats 76 as well as traction spikes 84 to sole 24 in a variety of configurations, as illustrated in FIGS. 13-16. The central span of bridge 120 is curved to correspond with the curve of sole 24, thus permitting bridge 120 to be embedded in and bonded to sole 24 in whole or in part. Optionally, bridge 120 can be made from a single horseshoe shape that extends around the entirety or only part of shoe 10. Likewise, bridge 120 can be disposed distally or laterally within sole 24, depending on the desired placement of cleats 76. Additionally, bridge 120 is provided with one or more fenestrations 140. Fenestrations 140 are encased by the polymer of shoe 10, thus rigidly securing bridge 120 within sole 24. Optionally, Support Bridge 120 includes a distal tab 110 that extends in a superior direction from sole 24. This distal tab facilitates proper placement and positioning of the horses hoof onto shoe 10 and can provide additional rigidity to the span of bridge 120.

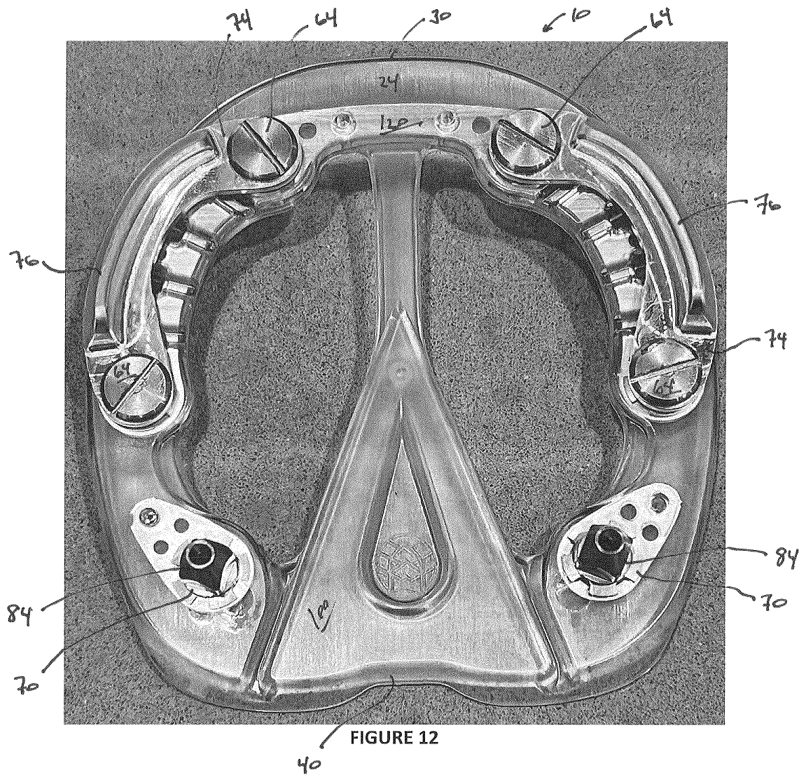

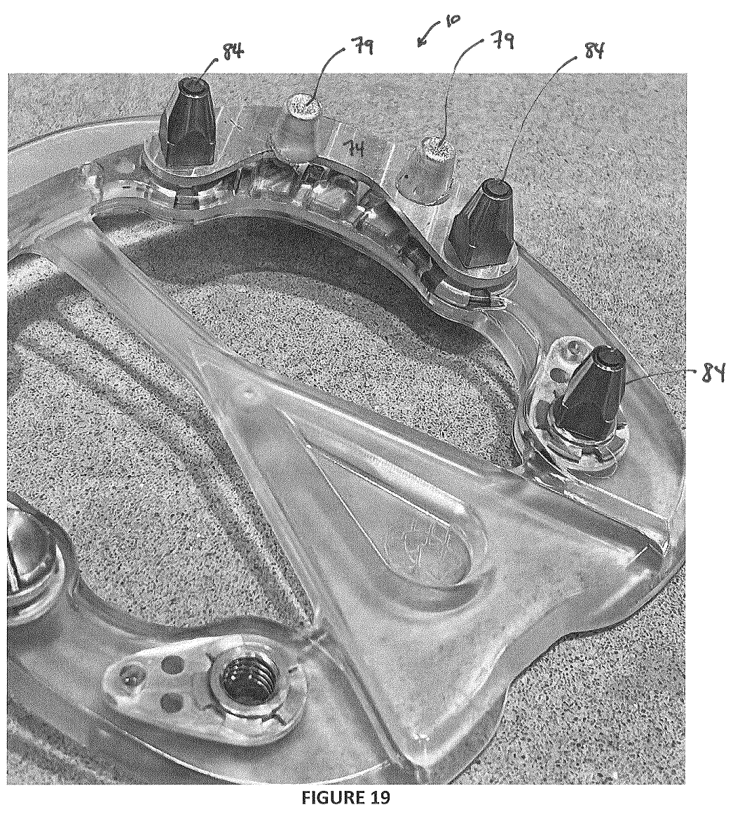

As shown in FIGS. 1-5 and 16-23, shoe 10 includes one or more interchangeable cleats 76, which preferably include a traction element such as a curved or straight wall, spikes or other ground engaging element. Generally, cleats 76 are formed from material sufficiently rigid to fully or partly penetrate challenging ground such as hard soil, frozen soil, mud, slush, snow or other natural ground covers. Cleats 76 can be formed of metal, metal alloys (e.g., aluminum, stainless steel), or rigid polymer, although other materials can be used depending on the desired performance characteristics of shoe 10. For example, metal cleats may be advantageous in frozen or hard soil, whereas softer polymers may be advantageous for sandy conditions. In other examples, the cleats can be rubber with impact absorbing qualities. Cleats 76 have a generally flat bracket 74, which is secured directly to sole 24 using screws, bolts, traction spikes or other similar fastening devices, as shown in FIGS. 12, 14 and 15. In one embodiment of the cleats, a curved wall 78 extends through all or part of inferior end 18 from bracket 74. Curved wall 78 is sloped in a distal direction, thus providing decreasing traction from the proximal end of curved wall toward the distal end. Cleats having a different configuration are also contemplated within the scope of the present disclosure, as shown in FIGS. 19-24. For example, depending on the desired level of traction and penetration, and the size and condition of the horse, a user can selectively use cleats with traction spikes, frustoconical cleats, a shorter/longer height, thinner/thicker width, or shorter/longer length, or ice spikes. Additionally, in some circumstances, spiked or serrated cleats are preferred. As a result, a user can highly customize and configure shoe 10 for use in a wide variety of conditions, terrain and applications.

In addition to cleats 76, shoe 10 is provided with traction spikes, which are preferably secured to the proximal-most tee nuts 70. Advantageously, as shown in FIGS. 13-15, shoe 10 permits the interchange of cleats 76 with traction spikes, thus providing for a number of different cleat/traction spike combinations that can be tailored to specific riding or use conditions.

Shoe 10 is configured to receive a horse hoof on superior end 170. As shown in FIGS. 6, the interior or central section of the shoe is generally formed in the shape of a segmented arc to comfortably accommodate and support the frog of the horse hoof. Accordingly, distal end 30 is shaped to receive the toe, while proximal end 40 is sized to receive the heel. Moreover, the shoe is sized such that the quarters of the horse hoof fits between tabs 110. The surface on which the horse hoof rests can be textured to improve comfort, support and retention of the shoe.

To fit the shoes 10, a user must first size each hoof. This can be accomplished by measuring the width and length of each hoof with a fit-kit, such as supplied by Easycare, Inc. Based on the width and length of each hoof, a shoe of a proper size is selected. Upon selection, the horse hoof is first prepared using traditional hoof care methods.

To manufacture shoe 10, the sole can be created from one or more aluminum blanks machined into the precise configuration shown FIG. 6. Likewise, bridge 120 can be formed, forged or machined with a properly configured CNC machine.

Depending on the intended use of the shoe 10, different durometer materials can be used for sole 24. For example, in one embodiment, the material forming the sole can be made of a higher durometer than the material forming the upper.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

1. An equine shoe comprising:
a polymer sole comprising:
a support bridge embedded in the sole;
a first tee nut, the first tee nut being connected to the support bridge;
a second tee nut, the second tee nut being connected to the support bridge;
a first faster;
a second fasteners; and
a cleat comprising a bracket and a wall extending from the bracket, the bracket being secured to the first tee nut with the first fastener and the second tee nut with the second fastener.

2. The equine shoe of claim 1, further comprising a frog support and a longitudinal support, the frog support extending from the sole, and the longitudinal support having one end attached to the frog support and another end attached to the sole.

3. The equine shoe of claim 2, further comprising:
a second support bridge embedded in the sole;
a third tee nut, the third tee nut being connected to the second support bridge;
a fourth tee nut, the fourth tee nut being connected to the second support bridge;
a third fastener;
a fourth fastener; and
a second cleat comprising a bracket and a wall extending from the bracket, the bracket being secured to the third tee nut with the third fastener and the fourth tee nut with the fourth fastener.

4. The equine shoe of claim 3, wherein the fasteners are traction spikes.

5. The equine shoe of claim 4, further comprising:
a fifth tee nut embedded in the sole;
a sixth tee nut embedded in the sole;
a fifth traction spike connected to the fifth tee nut; and
a sixth traction spike connected to the sixth tee nut.

6. The equine shoe of claim 1, further comprising:
a third tee nut embedded in the sole;
a fourth tee nut embedded in the sole;
a first traction spike connected to the third tee nut; and
a second traction spike connected to the fourth tee nut.

7. An equine shoe comprising:
a polymer sole comprising:
a support bridge embedded in the sole;
a first tee nut having a threaded region, the first tee nut being connected to the support bridge;
a second tee nut having a threaded region, the second tee nut being connected to the support bridge;
a third tee nut having a threaded region, the third tee nut being connected to the support bridge;
a fourth tee nut having a threaded region, the fourth tee nut being connected to the support bridge;
a first fastener, a second fastener, third fastener and a fourth fastener; and
a cleat comprising a bracket, the bracket being secured to the first tee nut with the first, second, third and fourth fasteners.

8. The equine shoe of claim 7, further comprising a frustoconical cleat extending from the bracket.

9. The equine shoe of claim 7, further comprising a wall extending from the bracket.

10. The equine shoe of claim 7, wherein the fasteners are traction spikes.

11. The equine shoe of claim 7, further comprising:
a fifth tee nut, the fifth tee nut being embedded in the sole;
a sixth tee nut, the sixth tee nut being embedded in the sole; and
a fifth fastener, the fifth fastener being connected to the fifth tee nut; and
a sixth fastener, the sixth fastener being connected to the sixth tee nut.

12. The equine shoe of claim 11, wherein the fifth and sixth fasteners are traction spikes.

13. The equine shoe of claim 11, wherein the fifth and sixth fasteners are bolts.

14. An equine shoe comprising:
a polymer sole comprising:
a support bridge embedded in the sole;
a first tee nut having a threaded region, the first tee nut being connected to the support bridge;
a second tee nut having a threaded region, the second tee nut being connected to the support bridge;
a first fastener;
a second fastener;
a cleat comprising a bracket and a traction element extending from the bracket, the bracket being secured to the first tee nut with the first fastener and the second tee nut with the second fastener;
a frog support extending from the sole; and
a longitudinal support extending between the sole and the frog support.

15. The equine shoe of claim 14, wherein the traction element is frustoconical.

16. The equine shoe of claim 14, wherein the traction element is a spike.

17. The equine shoe of claim 14, wherein the traction element is a curved wall.

18. The equine shoe of claim 14, wherein the traction element is a frustoconical cleat.

19. The equine shoe of claim 14, wherein the fasteners are traction spikes.
